(19) United States
(12) Patent Application Publication
(10) Pub. No.: US 2015/0005432 A1
(43) Pub. Date: Jan. 1, 2015

(54) FIBER-REINFORCED COMPOSITE MATERIAL

(71) Applicant: GM Global Technology Operations LLC, Detroit, MI (US)

(72) Inventors: Leonard Barry Griffiths, Fenton, MI (US); Michael A. Karram, Flint, MI (US); Peter H. Foss, Oxford, MI (US)

(21) Appl. No.: 13/929,182

(22) Filed: Jun. 27, 2013

(51) Int. Cl. C08K 3/40; C08K 3/34

(52) U.S. Cl. CPC C08K 3/40; C08K 3/34
USPC 524/494; 524/493

(57) ABSTRACT

A composite material is disclosed that includes a matrix binder material and a plurality of elongated fiber strands. The strands have a longitudinally extending central portion having two or more lobes extending radially from the central portion and disposed longitudinally along the strand.

### FIELD OF THE INVENTION

Exemplary embodiments of the invention are related to composite materials and, more specifically, to fiber-reinforced composite materials.

### BACKGROUND

Composite materials are well-known. One class of composite materials that is widely used in a variety of applications is the class of fiber-reinforced composites. Fiber-reinforced composites typically include a continuous phase, also called a matrix or binder, and also a discontinuous phase of fibers embedded in the binder. The fibers can be distributed into a mixture of the binder in a powder or fluid form prior to solidification, or the fibers can be in the form of a mat or fiber preform that is impregnated with binder to form the composite material. Although fiber-reinforced materials often utilize a polymer binder, other types of binders such as cement or metals can also be reinforced with fibers. Fiber-reinforced composite materials can provide significant benefits compared to homogeneous materials, including but not limited to strength, stiffness, impact resistant, strength to weight ratio, etc. However, new alternatives, which may offer performance benefits, are always welcome.

### SUMMARY OF THE INVENTION

In an exemplary embodiment of the invention, a composite material comprises a matrix binder material and a plurality of elongated fiber strands, the strands comprising a longitudinally extending central portion having two or more lobes extending radially from the central portion and disposed longitudinally along the strand. The lobes can have any shape, and in some embodiments the lobes comprise a radially-extending portion and a cap portion. In some embodiments the fiber has four lobes extending radially from the central portion of the strand. Longitudinal channels are thus formed between the lobes, which can be filled with matrix binder material in the composite material.

The above features and advantages and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of embodiments, the detailed description referring to the drawings in which:

FIG. 1A is a perspective view of an exemplary fiber for use in the composite materials described herein;

FIG. 1B is an end view of the exemplary fiber shown in FIG. 1A;

FIG. 2A is a perspective view of another exemplary fiber for use in the composite materials described herein; and

FIG. 2B is an end end view of the exemplary fiber shown in FIG. 2A.

### DESCRIPTION OF THE EMBODIMENTS

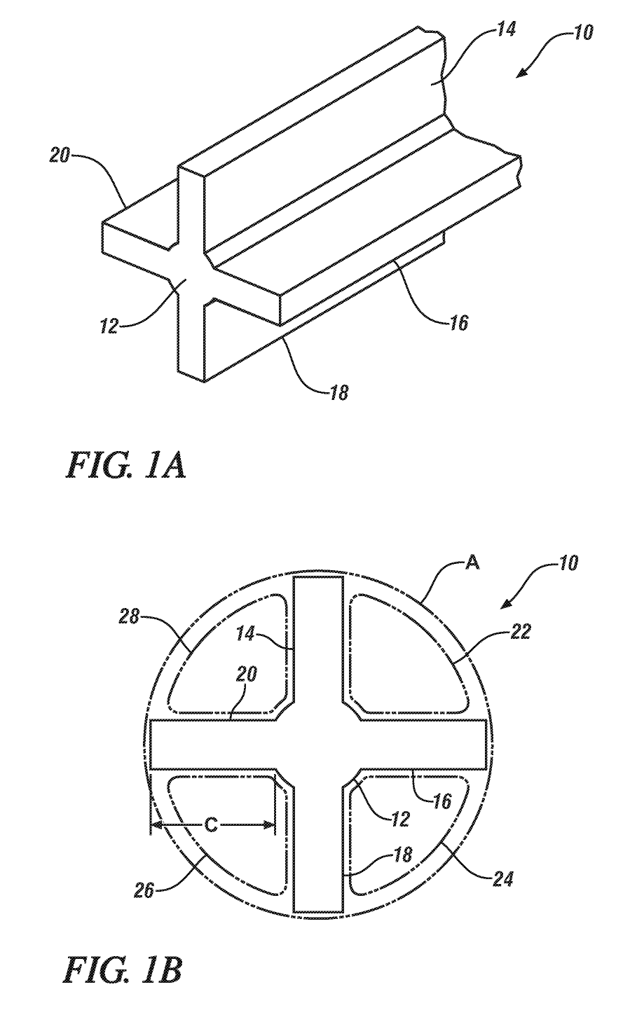

Referring now to FIGS. 1A and 1B, an exemplary fiber for use in the composite embodiment of the invention is depicted. As shown in FIGS. 1A and 1B, shaped fiber 10 has a longitudinally extending central or core portion 12. Lobes 14, 16, 18, and 20 extend radially from the central or core portion 12, and are disposed on the central or core portion 12 longitudinally along the strand. Additionally, channel portions 22, 24, 26, and 28 (FIG. 1B) are defined by adjacent lobe pairs 14/16, 16/18, 18/20, and 20/14, respectively. In the composite material, these channel portions will typically be filled by matrix binder material (not shown).

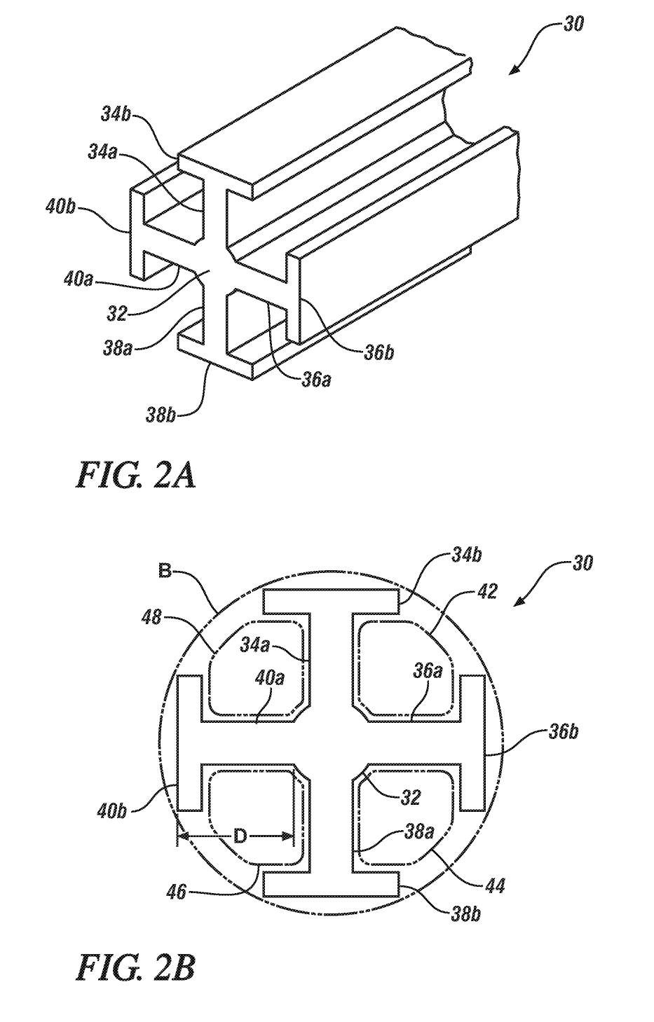

Referring now to FIGS. 2A and 2B, an exemplary fiber for use in the composite embodiment of the invention is depicted. As shown in FIGS. 2A and 2B, shaped fiber 30 has a longitudinally extending central or core portion 32. Lobes 34a-b, 36a-b, 38a-b, and 40a-b extend radially from the central or core portion 32, and are disposed on the central or core portion 32 longitudinally along the strand. Additionally, channel portions 42, 44, 46, and 48 (FIG. 2B) are defined by adjacent lobe pairs 34/36, 36/38, 38/40, and 40/34, respectively. In the composite material, these channel portions will typically be filled by matrix binder material (not shown). Each of the lobes 34, 36, 38, and 40 are comprised of radially-extending portion 34a, 36a, 38a, and 40a, and cap portion 34b, 36b, 38b, and 40b. The radial end view shown in FIG. 2B depicts the lobe and cap portions as T-shaped; however, the fiber can also have other cross-sectional profiles with a radially-extending portion and a cap portion. For example, the cap portion can be configured as upward or downward leading wings instead of the perpendicular T-shape shown in FIG. 2B. In some embodiments, the shape of a radial cross-section of the fiber is symmetrical and/or regular. In some embodiments, the lobe points of attachment are equally spaced along the circumference of the central or core portion of the fiber. In other embodiments irregular and/or assymetrical cross-sectional profile shapes or configurations can be used as well, limited only by manufacturing process and material handling capabilities.

The fibers used in the invention, including those discussed above shown in FIGS. 1 and 2, are referred to below as “lobed fibers”. The specific dimensions of the lobed fibers can vary based on a number of factors such as the target physical specifications of the composite material, the individual physical properties of the matrix binder material(s) and/or the fiber material(s), the fiber manufacturing technique, and/or the composite material manufacturing technique. The lobed fibers discussed herein can be described as having a diameter, with the term ‘diameter’ being defined, with respect to the lobed fibers, as the diameter of the smallest circle that can be fit around a radial cross-section of the fiber including the lobes. By way of example, the diameter of the lobed fibers from FIGS. 1 and 2 is depicted as circular dashed line A in FIG. 1B and circular dashed line B in FIG. 2B. In some exemplary embodiments, the lobed fiber can have a diameter of from 5 μm to 1000 μm, more specifically from 10 μm to 500 μm, and even more specifically from 50 μm to 250 μm. In one exemplary embodiment, the lobed fiber has a diameter of about 100 μm. In some exemplary embodiments, the fibers can have a length of from 5 μm to 1000 μm, more specifically from 10 μm to 500 μm, and even more specifically from 50 μm to 250 μm. In one exemplary embodiment, the lobed fiber has a length of about 500 μm. In some exemplary embodiments, longer fibers can be used, subject to fiber manufacturing and material handling capabilities. Longer fibers (up to and including continuous length fiber) can be used, for example, in the formation of fiber mats for composite materials, as opposed to dispersing fibers in a matrix binder material.

The dimensions of the lobes can be described as having a height, with the term ‘height’ being defined, with respect to the lobed fibers, as the distance between the outer edge of the fiber central or core portion, and the outer (radially from the center of the fiber) edge of the lobe. The height of one of the lobes 20, 40 in FIGS. 1B and 2B is depicted as dimension C in FIG. 1B and dimension D in FIG. 2B. In some exemplary embodiments, the lobes can have a height of from 2 μm to 400 μm, more specifically from 4 μm to 200 μm, and even more specifically from 20 μm to 100 μm. In one exemplary embodiment, the lobes have a height of about 40 μm. In some exemplary embodiments, the central or core portion of the fiber can have a cross-sectional diameter of from 1 μm to 200 μm, more specifically from 2 μm to 100 μm, and even more specifically from 10 μm to 50 μm. In one exemplary embodiment, the central or core portion of the fiber has a cross-sectional diameter of about 20 μm.

Lobed fibers for fiber-reinforced composite materials can be formed from a variety of materials. In some embodiments, inorganic fibers such as glass or ceramic fibers are used, and can provide beneficial properties such as high stiffness and strength, as well as durability and ability to withstand sever processing conditions. Examples of specific inorganic materials include glass fibers such as E-glass, S-glass, etc, or ceramics such as silicon carbide. Polymeric fibers such as aramid fibers, or other known reinforcing fibers such as carbon fibers can also be used. In addition, precursor fibers such as polyacrylonitrile (“PAN”) can be formed in a lobed shape before conversion to carbon fibers. Lobed fibers can be formed by extruding the fiber material in a fluid state. Ceramic or glass materials can be heated to a fluid state (e.g., from 900 to 1100° C., depending on the softening point of the material, and then extruded through a high temperature die (e.g., formed from a high temperature ceramic or mineral). Polymer fibers can be heated to a fluid state, typically at lower temperatures than ceramics or glass (e.g., 250 to 350° C.), and can typically be extruded through metal dies. The extruded fiber, still hot and deformable, is typically routed into a cooling zone such as a cold water bath to cool and solidify the binder material in the shape of the lobed fiber imparted by the die. Some polymers can be dissolved in solvent to form a thick dope-like material that can be extruded, followed by evaporation of the solvent, although shrinkage during solvent evaporation could result in deformation of the lobed fiber.

The matrix binder material can be any of a number of materials known to be used for this purpose, including polymers such as thermoset resins such as epoxy resins, polyurethanes, etc., and also thermoplastic polymers such as acrylic polymers, polycarbonates, nylons, polyesters, etc. Other types of matrix binder materials can also be used with the selection of an appropriate fiber material. For example, Portland cement, metals (e.g., aluminum), and rubber can also be used as matrix binder materials. In the case of metals, the fiber should have a higher melting point than the metal, so the choice of fiber may be limited to certain materials like ceramics, and the fibers may be in the form of a mat that is impregnated with molten metal.

Fiber-reinforced composite materials can be prepared using a variety of techniques, as is known in the art. With some techniques, the fibers are dispersed in the binder that is in powder or fluid form and the binder is molded and cured. For example, with a thermoplastic polymer binder, the fibers can be dispersed in polymer that has been heated to its fluid state (often called a “melt”), or they can be dispersed with polymer powder that is then heated to its fluid state. The fluid polymer with fibers dispersed therein can then be formed into a fiber-reinforced composite material by conventional techniques such as extrusion, injection molding, or blow molding. With thermoset polymers, the fibers can be dispersed among the reactive components, which are then cured to form the fiber-reinforced composite material. In some embodiments, a pre-formed fiber mat can be impregnated with a fluid matrix binder material that is then cured or otherwise solidified to form the fiber-reinforced composite material. Another common technique is to impregnate a pre-formed fiber mat with a curable resin such as an epoxy resin. This article, also called a pre-preg or pre-form, can then be incorporated into a layup on a mold, optionally along with other pre-forms or pre-pregs, and subjected to heat and/or pressure to cure the resin, thereby forming the fiber-reinforced composite. Similar and/or analogous techniques can be used with other matrix binder materials such as aluminum, where, for example, molten aluminum can be cast into a mold where a pre-formed mat of high-temperature ceramic fibers is disposed.

As is known in the art, the matrix binder material and the reinforcing fibers can be selected to provide individual physical properties that cooperate to provide a desired set of properties to the fiber-reinforced composite material as a whole. In some embodiments, reinforcing fibers are used to increase the stiffness of an article formed from the composite material, and the fiber material has a Young's modulus, E_{f}, that is higher than the Young's modulus of the matrix binder material, Eₘ. In some embodiments, the ratio of the modulus of the reinforcement to the matrix can be approximately 10. However, other fiber and matrix combinations that are much closer in properties can also be used such as a ratio of 8 to 12, for example. With respect to the above, Young's modulus values are at nominal ambient temperature (25° C.) or other specified operating temperature or temperature range for an article formed from the composite material. Such other operating temperatures could include temperatures from −40° C. to 200° C. or from −20° C. to 130° C., for example.

The invention is further described in the following non-limiting example.

### Example

Lobed fibers configured as shown in FIG. 1 and circular cross-sectioned fibers, each formed from a material having a Young's modulus, E_{f}, of 72 GPa at 25° C., and having a diameter of 100 μm, and a length:diameter aspect ratio as shown in Table 1, are dispersed in separate batches of a melt of a thermoplastic polymer matrix binder having a Young's modulus, Eₘ of 3 GPa at 25° C. and subjected to flow-induced deformation. The resulting composite material is subjected to analysis to determine Young's modulus along the axis of flow and transverse to the axis of flow. The results are presented in Table 1.

TABLE 1

| Fiber | Volume | Aspect | Flow | Transverse | Anisotropic |
|---|---|---|---|---|---|
| Type | Fraction | Ratio | Modulus | Modulus | Ratio |
| X | 0.11 | 5 | 6.38 | 4.48 | 0.70 |
| C | 0.11 | 5 | 4.90 | 4.13 | 0.84 |
| C | 0.11 | 16 | 7.02 | 4.07 | 0.58 |

X = LOBED FIBER,
C = CIRCULAR FIBER

The results in Table 1 show that the lobed fibers have a stronger stiffening effect than circular fibers of the same aspect ratio and volume fraction, and that the lobed fibers of lower aspect ratio and same volume fraction produce a significantly more isotropic material while maintaining stronger stiffness than typical molded circular fibers of higher aspect ratio and same volume fraction.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiments disclosed, but that the invention will include all embodiments falling within the scope of the present application.

What is claimed is:

1. A composite material, comprising:
a matrix binder material;
a plurality of elongated fiber strands, the strands comprising a longitudinally extending central portion having two or more lobes extending radially from the central portion and disposed longitudinally along the strand.

2. The composite material of claim 2, wherein the lobes comprise a radially-extending portion and a cap portion.

3. The composite material of claim 3, wherein a radial cross-section of the lobes is T-shaped.

4. The composite material of claim 1, wherein the longitudinally extending central portion has at least three lobes disposed thereon.

5. The composite material of claim 4, wherein the longitudinally extending central portion has four lobes disposed thereon.

6. The composite material of claim 1, wherein the longitudinally extending central portion has four lobes disposed thereon.

7. The composite material of claim 1, wherein the ratio of the Young's modulus of the reinforcement to the Young's modulus of the matrix binder ranges from 8:1 to 12:1.

8. The composite material of claim 6, wherein the ratio of the Young's modulus of the reinforcement to the Young's modulus of the matrix binder is about 10:1.

9. The composite material of claim 1, wherein the fibers are dispersed in the matrix binder.

10. The composite material of claim 1, wherein the fibers are in a woven or non-woven mat disposed in the matrix binder.

11. The composite material of claim 1, wherein the binder is a polymer binder.

12. The composite material of claim 11, wherein the polymer binder is an acrylic, a polycarbonate, a nylon, or a polyester.

13. The composite material of claim 12, wherein the fibers are glass or ceramic.

14. The composite material of claim 1, wherein the fibers have a diameter of from 5 μm to 1000 μm.

15. The composite material of claim 14, wherein the fibers have a diameter of from 50 μm to 250 μm.

16. The composite material of claim 14, wherein the fibers have a length:diameter aspect ratio of at least 1:1.

17. The composite material of claim 15 wherein the fibers have a length:diameter aspect ratio of 1:1 to 10:1.

18. The composite material of claim 1, wherein the weight ratio of fibers to binder is from 5:100 to 60:100.

19. The composite material of claim 18, wherein the weight ratio of fibers to binder is from 10:100 to 40:100.
